(19) United States
(12) Patent Application Publication
(10) Pub. No.: US 2012/0255364 A1
(43) Pub. Date: Oct. 11, 2012

(54) Method for employing titania nanotube sensors as vacuum gauges

(76) Inventors: Gregory A. Mulhollan, Dripping Springs, TX (US); John C. Bierman, Austin, TX (US); Robert E. Kirby, Cupertino, CA (US)

(21) Appl. No.: 13/506,280

(22) Filed: Apr. 9, 2012

Related U.S. Application Data
(60) Provisional application No. 61/516,867, filed on Apr. 11, 2011.

(51) Int. Cl. G01L 21/12

(52) U.S. Cl. 73/753; 73/700

(57) ABSTRACT

A method by which titania, or other composition, nanotube arrays, grown anodically or otherwise, can be made to meter vacuum pressure through hydrogen absorption has been discovered. The nanotube array (203) is fixed onto a demountable or permanently affixed flange, through which electrical current can be passed. By metering the current (205) for an allowable range of bias voltages (207), a resistance value (302) can be obtained. This resistance is related to the hydrogen pressure (202) through cross-calibration at the overlap with conventional gauges. Conventional gauges require free electrons for ionization of gas molecules, directly contributing to the pressure in the vacuum volume. The present invention avoids that complication by relying on the absorption of hydrogen. The method associated with this embodiment includes the mounting, bias, current measurement, restoration and boosting techniques all compatible with the operation of a vacuum vessel at very high, ultra-high and extreme-high vacuum levels.

### CROSS-REFERENCE TO RELATED APPLICATION

This application claims the benefit of PPA Ser. Nr. 61/516,867 filed Apr. 11, 2011 by the present inventors, which is incorporated by reference.

### FEDERALLY SPONSORED RESEARCH

This work was supported by the Department of Energy SBIR under Grant No. DE-SC0004437.

### DESCRIPTION

1. Field of the Invention

The present invention relates to a method for which titania, or other composition, nanotube arrays, or other high surface area materials, grown anodically or otherwise, can be made to meter vacuum pressure through hydrogen absorption. Specifically, the invention relates to the mounting, bias, current measurement, restoration and boosting techniques all compatible with the operation of a vacuum vessel at very high, ultra-high and extreme-high vacuum levels.

2. Background

Vacuum monitoring encompasses a wide variety of techniques and is employed in large numbers of technological endeavors. Direct measurement, process control and device interlocking are all vacuum gauge applications. The vacuum range (high: 1×10⁻³-1×10⁻⁶ Torr, very high: 1×10⁻⁶-1×10⁻⁹ Torr, ultra-high (UHV): 1×10⁻⁹-1×10⁻¹² Torr and extreme-high (XHV): <1×10⁻¹² Torr) determines the available vacuum gauges, as there are no gauges capable of covering the entire pressure range alone. At the lowest end, XHV, the vacuum gauge choices are fewer still even as the technology to achieve that vacuum level becomes more prevalent. XHV is most commonly utilized in photoinjectors for particle physics laboratories. However, as producing XHV becomes easier, its use in the production of micro-engineered machines and extreme ultraviolet mask patterning lithography will increase as well.

Although producing XHV conditions requires a careful choice of system materials, extensive material processing and complex pumping schemes, the more difficult task of actually determining the pressure is the most serious limitation in the routine use of XHV conditions. The only practical measurement of vacuum pressures in the upper ranges of UHV employs the creation of ions from residual gas molecules by electron impact, followed by ion collection and signal processing. Examples are the ion gauge and cold cathode gauge. To determine the true pressure, rather expensive species mass discrimination via residual gas analyzer is required as different gas species have different ionization cross sections and therefore, different sensitivities when measured. It is necessary in those cases to know both the gas makeup as well as its apparent pressure if an absolute pressure reading is required.

In the XHV range, however, two conditions make the ionization technique problematic: 1) There are only about 2500 cm⁻³ molecules to ionize at 10⁻¹³ Torr, so the inherent inefficiency of the electron-impact ionization process becomes signal limiting and 2) In addition to the ion gauge hot filament and supports acting as gas sources, the heat and electrons from both the gauge filament (ion gauge) and plasma discharge (cold cathode gauge) liberate gas from nearby surfaces, contributing to the overall pressure. These twin problems of sensitivity and accuracy have slowed further gauge development since the last significant gauge-type invention, the extractor gauge, in the 1960s. The extractor gauge was invented to compensate for another inherent difficulty with the ion gauge design, the x-ray limit. Cathode electrons that strike the grid have sufficient energy to produce soft x-rays that generate photo-electrons at the ion collector, providing an unknown offset collector current. While moving the collector out of sight from the grid diminishes the x-ray limit problem, the cathode heat and electron-stimulated gas desorption problems remain.

Sorption type vacuum sensors were pioneered in the 1960's. An example is the detection of hydrogen partial pressures by change in the work function of a hot palladium wire. However, they suffered from several drawbacks which made them curiosities rather than commercial successes. First, they employed a heated element to increase the reaction rate at the surface of the sensor wire. Such a hot source, with the disadvantage of single-species sensitivity, made the sensor more suited to specific gas detection rather than total pressure monitoring, i.e, it was inferior to the simpler, cheaper ion gauge. Second, the cross-species sensitivity was greater than nil, so that hydrogen could not be detected absolutely when oxygen was present. Lastly, the high price of palladium wire made the entire assembly costly.

It is not necessary for an XHV vacuum gauge to cover higher pressure ranges. Ion and cold cathode gauges meter these ranges quite well and with known sensitivities. An XHV gauge need only come on line as the pressure trends below the limits of other gauge types. Upon inspection of the gas makeup at XHV, it is clear that it is completely dominated by hydrogen. A vacuum gauge solution in which only hydrogen is accurately metered is ideal for XHV pressure monitoring.

### SUMMARY OF THE INVENTION

An object of the invention is to overcome at least some of the drawbacks relating to the methods of prior art as discussed above.

Hence, a method is provided for which titania, or other composition, nanotube arrays, or other high surface area materials, grown anodically or otherwise, can be made to meter vacuum pressure through hydrogen absorption. Conventional methods employ the use of a hot filament or a plasma discharge, thereby ionizing the background gas molecules such that they can be collected and signal processed, to meter the vacuum pressure.

In the improved gauging method, a titania, or other composition, nanotube array, or other high surface area material, is caused to be mounted onto a vacuum compatible feedthrough. This feedthrough permits a bias to be applied across the array, resulting in current flow. The resulting current flow, together with the bias value, allows an effective resistance to be calculated. The value of this resistance is proportional to the hydrogen impingement and restorative exposure history of the array, thereby enabling hydrogen as a vacuum constituent to be monitored. The ensuing gauging process has been shown to deliver excellent hydrogen gas response in vacuum with sufficient measurement sensitivity for XHV vacuum monitoring.

Continued hydrogen absorption leads to reduced resistance and therefore increased current through the array. To return (diminish) the current to allowable values, it is necessary to apply a restorative to the array. The restorative may be applied through chemical, thermal, electronic or kinetic means. Molecular oxygen is an effective chemical restorative for titania nanotube arrays. A chemical restorative agent can be brought to the array surface via leak valve, tube, membrane, catalytic or chemical reaction in the vessel containing or connected to the array or any other method which produces a necessary partial pressure or freely migrating atoms of the oxidizing agent in such a manner as to allow it to react with the array surface.

Increased hydrogen sensitivity is obtained when the array's free charge carrier density is enhanced by application of energetic photons. Performance increases as the photon energy is raised with minimal response improvement obtained for illumination by red photons but with large response increase achieved for illumination by blue photons. Application of this technique to titania nanotube arrays is necessary to achieve the requisite sensitivity for gauging hydrogen pressures in the XHV range.

In other aspects, the invention provides a method of nanotube array sensor to vacuum gauge conversion having features and advantages corresponding to those discussed above.

### BRIEF DESCRIPTION OF THE DRAWINGS

The present invention is illustrated by way of example and not limitation in the accompanying figures:

FIG. 1 shows the resistance of a titania nanotube array as a function of cyclic gas exposure to dry air and low concentration hydrogen, all at atmospheric pressure.

FIG. 2 schematically represents the mounting, biasing, metering and hydrogen detection phases for a titania nanotube array within a vacuum envelope.

FIG. 3. shows an example of the hydrogen sensitivity of a titania nanotube array when exposed to hydrogen gas while under vacuum.

FIG. 4. illustrates the requirement for a quantitative signal to be extracted from the resistance value when it is smeared by the presence of Gaussian noise.

FIG. 5. shows an example of the increase, when under vacuum, in the hydrogen sensitivity of a titania nanotube array upon illumination.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

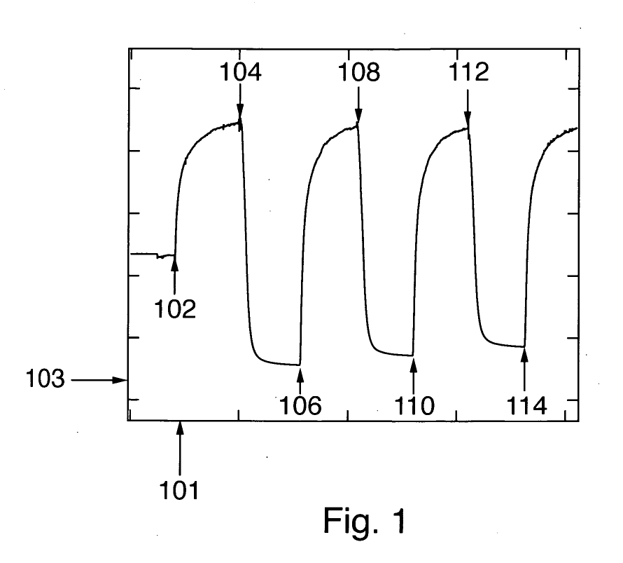

FIG. 1 illustrates the hydrogen 202 response obtained from a titania nanotube array 203 using the methods familiar to practitioners of the art. The abscissa 101 represents the time and the ordinate 103 represents logarithmically the electrical resistance, as derived from the measured current with an applied bias of 0.4 V. The abscissa 101 covers a time range of 0 through 42 minutes. The ordinate 103 covers a resistance range of 5 kΩ to 4 Ga The resistance, as obtained from the titania nanotube array, was generated by cycling between dry air, composed of 80% nitrogen and 20% oxygen 102,106,110,114 and a reacting mixture composed of 1 part per thousand hydrogen with the balance nitrogen 104,108,112. Flow rates were the same for both gas types, 1.0 standard cubic feet per hour. Both gas mixtures were administered by flowing through the encapsulating volume 201 at a pressure slightly over atmospheric pressure. A response at atmosphere pressure provides the minimum baseline required for utilization as a hydrogen sorbing gauge at vacuum pressures. Sensitivity under vacuum is enhanced by the transition of mass transport from viscous flow at atmospheric pressures to molecular flow at UHV and XHV.

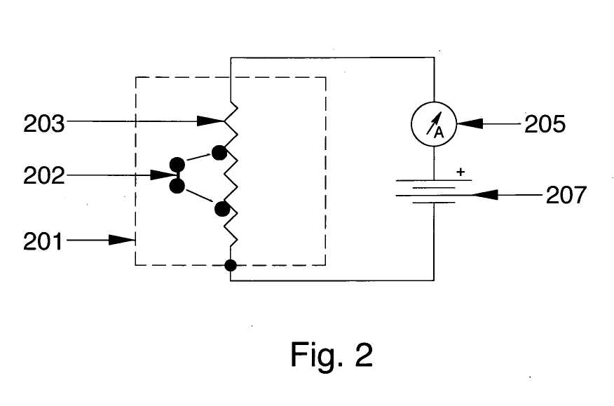

Turning now to FIG. 2, the method of mechanical mounting, electrical connection, bias and current monitoring in one embodiment of the method, employing a titania nanotube array, is depicted. Titania nanotube arrays 203 are mounted within the walls of a vacuum vessel 201. The materials used to mount the array need be compatible with vacuum systems as is known to practitioners of the art. Electrical connections can be single, double or multiple ended, with a single ended configuration shown in FIG. 2. The single ended configuration is rightly termed pseudo-single ended as one end is a shared common ground. Connected between two points is a bias supply 207 and a current meter 205. For accurate measurements, the bias supply 207 must provide stability and noise immunity. The current meter 205 must not interject voltage noise, such as may originate from any automatic self-calibration routine, into the circuit above the bias value the array 203 can withstand. The output form of the bias supply 207 may be time independent or time varying, depending on the detection scheme utilized by the current meter 205. In extremely electrically noisy environments, it may be advantageous to perform phase-locked detection of the current signal, thereby requiring a time varying bias supply 207. The hydrogen 202 exposure induced current change with time is due to the impingement of diatomic hydrogen molecules and their subsequent disassociation and chemical binding 202 to the nanotube array 203. This binding is reflected by a change in the charge carrier density and subsequently the conductivity and thereby the bias 207 induced current.

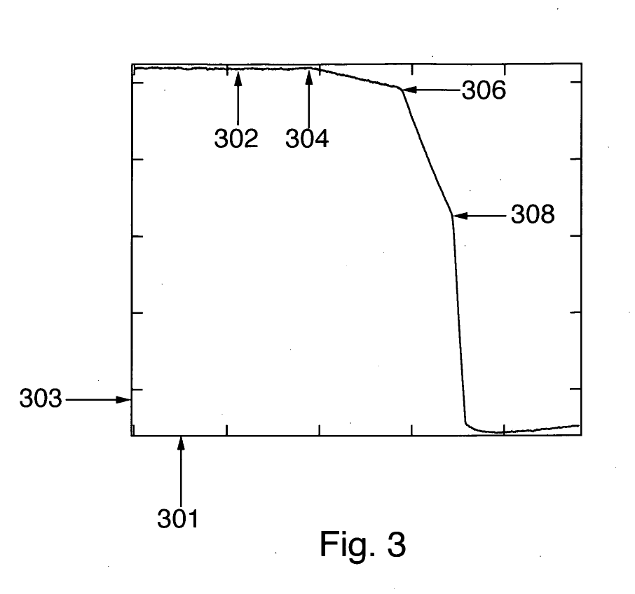

An example resistance change with hydrogen uptake under vacuum curve 302 incorporating the method for mechanical mounting, electrical connection, bias and current monitoring is illustrated in FIG. 3. The abscissa 301 represents time as measured via a computerized data acquisition program, strip-chart recorder or other time marking device and the ordinate 303 represents linearly the electrical resistance, as derived from the measured current with an applied bias of 0.4 V. The abscissa 301 covers a period of 25 minutes. The ordinate 303 covers a range of 62 to 86 kΩ. At the start of the dosing 304, the system pressure was 3×10⁻⁸ Torr, predominantly hydrogen. Each line segment represents dosing at an elevated pressure of hydrogen 202 admitted into the vacuum vessel 201 by a variable leak valve. The dosing pressures were 1×10⁻⁷ Torr 304, 1×10⁻⁶ Torr 306 and 1×10⁻⁵ Torr 308. Analysis of the characteristic curve 302 of each hydrogen detector 203 provides the expected response at UHV and XHV. For slowly time varying resistance values, it may be necessary to perform a mathematical analysis upon the raw data to determine the rate of change and thereby the expected pressure response at lower pressures so as to compensate for environmental, measurement-induced and sensor self-generated noise in the qualification apparatus.

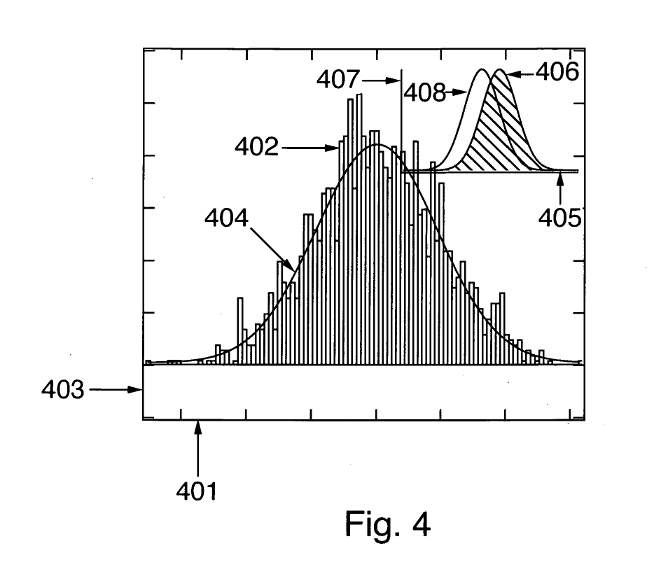

FIG. 4 illustrates a method for performing an analysis upon a slowly time varying resistance signal so as to extract a noise-compensated resistance value and to quantify the effective noise width which sets limits upon the minimum time required for a change in signal to be determined to have had occurred. Beginning with a slowly varying signal, such as between two dosing pressures, 304 and 306 or 306 and 308, a straight line is fit to the signal. This fit provides a slope which defines the sensitivity of the device in resistance change per number of hydrogen molecules arriving at the array surface per unit time via the known pressure value and standard gas statistical theory as is well known by practitioners of the art. A change in signal is therefore determined to have occurred when the newly recorded value 408 has deviated sufficiently from the previous value 406 that a distinction can be made. The conditions can be quantified when the noise distribution 402 is regular. If the slope is subtracted from the raw data and the result binned and subsequently histogrammed 402, the result will appear as shown in FIG. 4. The abscissa 401 represents the resistance value difference between the average (slope) and the flattened data. The ordinate 403 represents the number of values for a given difference. When regular, the distribution 402 may be fit using an appropriate analytic function 404. From the fit noise distribution, estimates may be made for the time required for the signal to shift sufficiently to be detected. When the fit curves are plotted on their own abcissa 405 and ordinate 407, their difference, for the gaussian curve employed 404, can be readily visualized. A single gaussian width shift between the old 406 and new 408 data values is readily noticed. Smaller shifts are easily determined using automatic curve fitting. However the simple, visual indication of the change between the before 406 and after 408 curves provides a go/no go threshold for screening nanotube arrays 203 as sufficienty sensitive for gauge use at UHV or XHV.

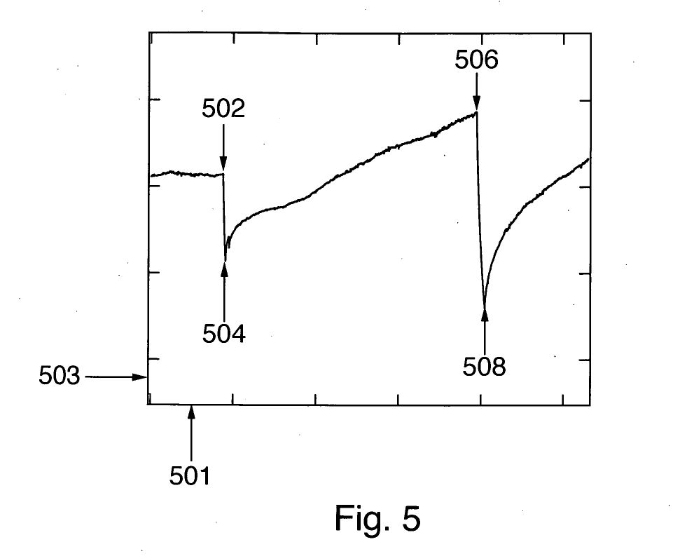

Turning now to FIG. 5, the sensitivity to hydrogen under vacuum exposure is proven to be enhanced by the use of optical excitation. The abscissa 501 represents time and the ordinate 503 represents the electrical resistance, as derived from the measured current with an applied bias of 0.4 V. The abscissa 501 of covers a range of approximately 53 minutes. The ordinate 503 covers a range of 90 to 175 kΩ. The titania nanotube array was exposed to 405 nm laser light 502 506 for short periods, followed by response recording in the absence of applied light 504 508. In both instances, upon illumination, the response to the background hydrogen immediately increased by more than 10× the previous rate, resulting in an effective shortening of the response time at lower pressures. The resistance rose once the light ceased 504 508 indicating that while the hydrogen response increased, the actual strongly bound hydrogen was not affected, meaning the bound sites were only stable under illumination. This provides yet another resistance restoration route; if the device approaches saturation, the illumination can be ceased for a period to allow the weakly bound hydrogen to desorb with illumination reinitiated after the restoration cycle has completed, thereby returning the array to a measurement mode. Photon response at 670 nm was very weak, however, response at 532 nm was similar to that of the 405 nm illumination with the primary difference being that the response saturated sooner with the less energetic photons. The response has been determined to be power dependent as well, so that a more powerful 532 illumination source may be substituted for a lower power 405 nm source and vice versa.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A method for employing sorbing hydrogen detectors as vacuum gauges. The gauging conversion method is for those sorbing detectors ordinarily used for hydrogen detection at atmospheric pressures to employ vacuum compatible mounting, bias, monitoring, restoration and boosting.

2. The method according to claim 1, wherein the mounting feedthrough is single ended.

3. The method according to claim 1, wherein the mounting feedthrough is double ended.

4. The method according to claim 1, wherein the mounting feedthrough is more than double ended.

5. The method according to claim 1, wherein the bias is delivered via electrical feedthrough from outside the vacuum wall.

6. The method according to claim 1, wherein the bias is delivered via electrical feedthrough from inside the vacuum wall.

7. The method according to claim 1, wherein the bias is delivered as a constant value.

8. The method according to claim 1, wherein the bias is delivered as a time varying value.

9. The method according to claim 1, wherein the current is monitored from outside the vacuum wall.

10. The method according to claim 1, wherein the current is monitored from inside the vacuum wall.

11. The method according to claim 1, wherein the restorative used is thermally released oxygen.

12. The method according to claim 1, wherein the restorative used is leak valve delivered oxygen.

13. The method according to claim 1, wherein the restorative used is silver tube delivered oxygen.

14. The method according to claim 1, wherein the restorative used is heat delivered by an infrared source within the vacuum wall.

15. The method according to claim 1, wherein the restorative used is heat delivered by a resistive film affixed on the opposing substrate side as the sensor assemblage.

16. The method according to claim 1, wherein the restorative used is heat delivered by a resistive film affixed on the same substrate side as the sensor assemblage.

17. The method according to claim 1, wherein the restorative used is heat delivered by a radiative source outside the vacuum wall.

18. The method according to claim 1, wherein the hydrogen uptake rate is increased by illumination from inside the vacuum wall.

19. The method according to claim 1, wherein the hydrogen uptake rate is increased by illumination from outside the vacuum wall.

20. The method according to claim 1, wherein the hydrogen uptake rate is increased by charged particles directed at the sensor assemblage.
